(19) United States
(12) Patent Application Publication
(10) Pub. No.: US 2006/0062948 A1
(43) Pub. Date: Mar. 23, 2006

(54) Heating container sleeve or tape

(75) Inventor: Robert John Kalishek, Appleton, WI (US)

Correspondence Address: APPLETON PAPERS INC.;LAW DEPARTMENT, 825 E. WISCONSIN AVENUE, PO BOX 359, APPLETON, WI, 54912-0359, US

(73) Assignee: Appleton Papers Inc., Appleton, WI (US)

(21) Appl. No.: 10/942,920

(22) Filed: Sep. 17, 2004

(51) Int. Cl. B32B 37/00; F16B 4/00

(52) U.S. Cl. 428/34.9; 156/272.2; 428/34.2; 428/182; 428/36.9

(57) ABSTRACT

The present invention is a container sleeve or alternatively a pressure sensitive tape having coated thereon or therein an energy receiver material which heats in response to microwave energy. The container sleeve or pressure sensitive tape substrate can be advantageously employed with conventional thermally imaging record materials in the form of a label, such as used on prescriptions, to facilitate preserving patient information confidentiality by obscuring information when contacted with microwave energy.

### BACKGROUND OF THE INVENTION

1. Field of the Invention

This invention relates to pharmaceutical containers, particularly pharmaceutical containers adapted for compliance with security of patient confidential information. More particularly the invention relates to such containers utilizing thermally imaging labels. The invention in particular relates to container sleeves and pressure sensitive tapes for prescription containers.

2. Description of the Related Art

With increasing concerns relating to information security, prevention of identity theft, and protection of personal privacy, a variety of techniques have been adopted to preserve the confidentiality of printed information, especially when used containers are discarded. These techniques include shredding, burning, and other means of information destruction. With passage of ever more stringent privacy obligations such as patients rights bills, and other legislation, such as HIPPA requirements in the U.S., there is an increasing need to control private information to maintain confidentiality, reduce liability exposure, reduce risk of administrative agency imposed fines for non-compliance and prevent careless or inadvertent disclosure of private information.

One solution that has been proposed Kalishek et al. Ser. No. 10/872,010 focuses on use of prescription labels formed of thermally responsive record material. To preserve patient confidentiality an energy receiver material such as a microwave susceptor is proposed to be added as a subbing layer, back coat, or integrated into the paper furnish.

By inductive or microwave heating, the patient information on the prescription label can be conveniently obscured through imaging of the heat sensitive composition of the thermally responsive record material.

It would be advantageous to extend the convenience of the Kalishek et al. system to prescription labels formed of conventional thermal record materials.

Thermally-responsive record material systems are well known in the art and are described in many patents, for example, U.S. Pat. Nos. 3,539,375; 3,674,535; 3,746,675; 4,151,748; 4,181,771; 4,246,318; 4,470,057 which are incorporated herein by reference. In these systems, basic chromogenic material and acidic color developer material are contained in a coating on a substrate which, when heated to a suitable temperature, melt or soften to permit said materials to react, thereby producing a colored mark.

Thermally-responsive record materials are typically imaged by use of a thermal print head that is moved across the sheet (serial type) or against which the sheet is moved. The thermal printhead can span the width of the sheet (line type). The thermal printhead typically has resistive heating elements. A microprocessor is used to selectively heat the individual heating elements to produce the desired image. Typically the finer the heat elements, the less power is required to produce dots that make up the image. The finer the dots and concentration of dots per unit area, the higher is the resolution.

Thermally-responsive record material systems due to their ease of use, low cost, high resolution, and simple operation have gained acceptance supplanting dot matrix printing in many applications.

It would be advantageous if patient personal information could be safeguarded when prescription containers are discarded.

### SUMMARY OF THE INVENTION

The invention is a substrate such as a sleeve or pressure sensitive tape having applied thereon or therein an energy receiver material for heating the substrate in response to electromagnetic energy such as microwaves.

The invention is particularly adapted for use with thermally imaging labels such as found on prescription containers for medicines, pills and tables. Such containers are typically cylindrical darkened plastic or bottles having a label adhered to the external surface.

When such labels are made of thermally imaging record material, the invention describes a device for facilitating rapid and convenient destruction of confidential information on such labels when such containers are discarded to preserve confidentiality of patient information.

The present invention teaches a sleeve or tape which can be applied to thermally imaging labels. The sleeve or tape heats in response to microwaves resulting in obscuration of the information thermally imaged on the label.

The invention is a container sleeve comprising a tubular member comprising a substrate and at least one opening therein for receiving and retaining a container, said tubular member comprising a substrate having applied thereon or therein an energy receiver material for heating the container sleeve in response to electromagnetic energy.

In one embodiment, the tubular member has openings at the top and bottom for sliding of the container sleeve onto a container. Preferably the energy receiver material is a microwave susceptor applied to a surface of the container sleeve, and more preferably the energy receiver material is a microwave susceptor particle, applied as a coating having microwave susceptor particles dispersed therein. Alternatively the energy receiver material comprises a layer of metallized film.

In yet another embodiment, the energy receiver material is a microwave susceptor dispersed within the substrate, within an adhesive on the substrate, or within a coating applied to the substrate. The substrate can comprise at least one layer of a polymeric material, such as a polymeric foam, a polyacrylate or other polymeric film and the like. Combination laminates of polymeric material and cellulosic material are possible, alternatively the substrate is a laminate of one or more plies of a cellulosic material. Optionally, in addition at least one ply can be corrugated, dimpled or fluted.

A wide variety of choices are available for materials selection. For example at least one ply can be selected from film, polymer, foam, paper, or fiberboard.

In another embodiment a pressure sensitive tape is described comprising a substrate having a top and bottom surface and having applied thereon or therein an energy receiver material for heating the pressure sensitive tape in response to electromagnetic energy and an adhesive layer applied to a surface of the substrate.

The energy receiver material can be a microwave susceptor applied to a surface of the substrate. It can be microwave susceptor particles or the energy receiver material can comprise a layer of metallized film.

The energy receiver material can be dispersed within the substrate or within the adhesive layer. Various constructs and laminations of the tape are possible.

The pressure sensitive tape substrate can comprise at least one or more layers of a polymeric material, or one or more plies of a cellulosic material, such as paper or paperboard or combinations of film, foam, paper or paperboard. Corrugating, dimpling, or fluting of any of the plies is optional.

### BRIEF DESCRIPTION OF THE DRAWINGS

FIG. 1 is a side view of a prescription container shown with a sleeve positioned over the prescription container label.

FIG. 2 is an alternate embodiment of a corrugated sleeve according to the invention.

FIG. 3 is an alternate embodiment of a foam sleeve.

FIG. 4 depicts a sleeve blank.

FIG. 5 is a cross-section of an alternate embodiment.

FIG. 6 is a cross-section of an alternate embodiment.

### DETAILED DESCRIPTION

In its general sense the invention is a substrate such as a sleeve or pressure sensitive tape having applied thereon or therein an energy receiver material for heating the substrate in response to electromagnetic energy. Optionally a pressure sensitive adhesive can be applied to a surface of the substrate to facilitate adherence of the substrate.

More particularly, the present invention is a container sleeve comprising a tubular member comprising a substrate and at least one opening therein for receiving and retaining a container. The tubular member comprises a substrate having applied thereon or therein an energy receiver material for heating the container sleeve in response to electromagnetic energy.

In one embodiment the invention is a sleeve, with at least one opening therein for receiving and retaining a container such as a pharmaceutical container for dispensing tablets or other medicines. The sleeve can be tapered toward the bottom if desired to facilitate a snug fit over the pharmaceutical container or prescription bottle.

The sleeve can have one or two openings such as holders for coffee cups.

The sleeve can be made of polymeric or cellulosic material such as paper, fiberboard, or kraft or corrugated material. Alternatively the sleeve can be made of one or more plies each optionally selected from any of the foregoing materials.

The sleeve according to the invention includes at least one layer of a material susceptible to inductive heating.

In an alternate embodiment the substrate is fashioned into a pressure sensitive tape intended to be applied onto a thermally imaging record material such as a thermally imaging label. The pressure sensitive tape comprises a substrate which can be cellulose based such as paper, cardboard or fiberboard. Alternatively the substrate can be polymeric or film based such as polyolefin and the like without limitation. The substrate is preferably flexible and selected from any material which is conventionally utilized as a tape or may be of any other flexible material. Examples include, but are not limited to, paper, flexible foams, plastic films such as polyolefins including polypropylene and polyethylene, or polyvinyl chloride, polyester (polyethylene terephthalate), polycarbonate, polymethyl(meth)acrylate (PMMA), cellulose acetate, cellulose triacetate, and ethyl cellulose. Other useful flexible substrates include, but are not limited to, woven fabric formed of threads of synthetic or natural materials such as cotton, nylon, rayon, glass, or ceramic material, or they may be nonwoven fabric such as air-laid webs or natural or synthetic fibers or blends of these. The substrate can also be a laminate comprising plies of any of the foregoing. The substrate external surfaces, namely the top and bottom surfaces have applied to at least one surface thereon or therein an energy receiver material for heating the pressure sensitive tape in response to electromagnetic energy such as microwave or radio frequency, infrared or high frequency radiation. An adhesive is applied to one surface. It can be an opposite or same surface to which the energy receiver material is applied. The energy receiver material can be dispersed alternatively in the adhesive or embedded in the substrate itself or any ply thereof, applied as a top coat or subcoat or applied as a metalized film layer over or under the substrate.

The pressure sensitive adhesive can take the form of any of a variety solvent-based, water-based, hot melt, microwave or radiation curable formulations. Various acrylate, methacrylate, styrene butadiene copolymer pressure sensitive adhesives are known. Pressure sensitive adhesive compositions are taught in patents such as U.S. Pat. Nos. 6,423,392; 6,218,006; 5,827,609; and 5,738,939 incorporated herein by reference.

Examples of pressure sensitive adhesive includes silicones, polyolefins, polyurethanes, polyesters, acrylics, epoxies, rubber-resin, and polyamides. Suitable pressure sensitive adhesive include solvent-coatable, hot-melt-coatable, radiation-curable (E-beam or UV curable) and water-based emulsion type adhesives that are well-known in the art. Specific examples of suitable adhesives include acrylic-based adhesives, e.g., isooctyl, acrylate/acrylic acid copolymers and tackified acrylate copolymers; tackified rubber-based adhesives, e.g., tackified styrene-isoprene-styrene block copolymers; tackified styrene-butadiene-styrene block copolymers; nitrile rubbers, e.g., acrylonitrile-butadiene; silicone-based adhesive, e.g., polysiloxanes; and polyurethanes. Typical thickness of the adhesive layers are 10 microns to 1000 microns and usefully 25 microns to 250 microns. Optionally the adhesive layer can contain a dispersion of particles of the energy receiver material or microwave receptor.

Also, optionally, the pressure sensitive adhesive can be microencapsulated or incorporated in a matrix material such as a rupturable polymeric material or rupturable gel. Microencapsulated pressure sensitive adhesives are known in the art and are often conveniently classified based upon mode of activation, extent of component microencapsulation, adhesive chemistry, or suitability for various surfaces.

Microencapsulated pressure sensitive adhesives can involve solvent-based systems or reactive or curable resin systems. Solvent-based systems rely on adhesive reactivation through solvent delivery. Microcapsules can be used as the vehicle to retain the solvent until needed. Other activatable systems rely on the plasticizer or UV initiator being encapsulated in place of solvent in order to tackify the resin at the time of use.

Capsules containing a solvent for the adhesive are typically dispersed throughout a nontacky adhesive coating on a substrate. Upon rupture of the capsules, a solvent is released making the adhesive tacky. A plasticizer can similarly be encapsulated and used in place of or in conjunction with a solvent to tackify the adhesive.

Reactive resin systems typically involve an encapsulated curing system. Either the total formulation, the total adhesive or one component can be encapsulated. Reactive components typically must be isolated or kept separate until use. Typically one or two separate encapsulations can be used. Reactive systems typically employ epoxy resins, isocyanates, polyesters and the like.

Another form of encapsulated adhesive is the self-contained capsule. The complete adhesive can be encapsulated, and applied to the substrate surface with a binder. Alternatively, a curing agent can be adhered to the capsule surface. Upon rupture of the capsule wall, the resin flows to contact the curing agent. Curing agent can include boron trifluoride complexes, nitrile or aniline type catalysts, acid chlorides, hexamethylenetetramine, various oxides, dibutyltin dilaurate and the like.

Capsule release mechanisms can involve pressure, heat or dissolution of the capsule wall. Heat activated systems thermally cure upon heating above the activation temperature. With all such systems pressure on the substrate can assist affixing the pressure sensitive tape or substrate.

Coating can be applied by any conventional means such as air knife, blade, rod, flexo, slot die, slot fed curtain, multi-layer slot die, multi-layer slot die fed curtain, slide die, slide die fed curtain, multi-layer slide die fed curtain and the like.

By “induction” or “inductive heating”, it is meant that the energy receiver material absorbs energy such as microwave, infrared, radio frequency, or magnetic, and the term is intended liberally to encompass electromagnetic induction, RF (radio frequency), microwave, infrared and dielectric heating. Inductive heating for purposes hereof differs from conventional heating primarily in that no open flame is used, fumes are minimized and the inductive heating devices generally can be designed with cool-to-the-touch exteriors as is commonly observed for example with microwave ovens.

The material susceptible to inductive heating is an energy receiver material and preferably comprises a microwave susceptor meaning a microwave absorber, RF absorber, or dielectric material. A microwave susceptor is more preferred. The energy receiver material or microwave susceptor can take the form of a metallized film, metal coatings, various particles including metal particles, silicon carbide, carbon fibers, metal oxides, ferrite particles, metal fibers, metallic flakes, nonconductive composites of energy dissipative materials or particles dispersed in a dielectric binder, by way of illustration and not limitation. Materials such as bronze powders, graphite, and aluminum flake, were used in the examples herein producing substrates that heated rapidly and obscured sensitive information when placed in a conventional microwave oven for about 30 seconds.

By “particle,” “particles,” “particulate,” “particulates,” “powder,” “fibers,” “flakes” and the like, it is meant that a material is generally in the form of discrete units. The particles can include granules, pulverulents, powders, spheres or flakes. Thus, the particles can have any desired shape such as, for example, cubic, rod-like, polyhedral, spherical or semi-spherical, rounded or semi-rounded, angular, irregular, flat or plate-like, etc. Shapes having a large greatest dimension/smallest dimension ratio, like needles, flakes and fibers, are also contemplated for use herein. The use of “particle” or “particulate” may also describe an agglomeration including more than one particle, particulate, or the like.

The term “surface” and its plural generally refer herein to the outer or the topmost boundary of an object, unless the context indicates otherwise.

As used herein, the terms “in proximity to” or “in intimate association” and other similar terms are intended to encompass configurations including the following: those where at least a portion of the material susceptible to inductive heating or energy receiver material is in contact with or proximate to or under or over a portion of the heat sensitive layer; and/or those where at least a portion of an energy receiver material is in contact with a portion of another energy receiver material such as in, for example, a layered or mixed configuration, over or under the heat sensitive layer (including over or under intervening intermediate layers) or as an underside coating of the substrate, such as paper substrate.

A suitable energy receiver material absorbs energy at the desired frequency (typically between about 0.01 to about 300 GHz) very rapidly, in the range of fractions of a second or a few seconds. In practice, the substrate coated with the energy receiver material was found to heat the overall substrate to a temperature approaching 150° C. to 235° C. sufficient to darken the heat sensitive composition after about 30 seconds in a microwave oven. Shorter or longer times would be expected depending on the loading in the microwave oven, amount of absorber and the like.

It should be understood by the discussion relating to metalized film and metallic particles that the inductive heating mechanism herein and the energy receiver material is not limited to dielectric materials. Microwaves for example are known to heat polar molecules. Conductive particles also heat in a microwave environment due to induced currents and electrical resistance. With very conductive materials arcing can be observed resulting in localized hot spots. Conductive inclusions in a non-conductive material are also known to be useful as a microwave absorber and heat by a combination of conductive and polarization effects. The invention is not limited to one mechanism or theory of inductive heating.

With high frequency dielectric heating or microwave heating the energy receiver material typically has a dielectric constant that is relatively high. The dielectric constant is a measure of how receptive to high frequency energy such as microwave energy a material is. These values apparently can be measured directly using instruments such as a Network Analyzer with a low power external electric field (i.e., 0 dBm to about +5 dBm) typically over a frequency range of about 300 kHz to about 3 GHz, although Network Analyzers to 20 GHz are readily available. For example, a suitable measuring system can include an HP8720D Dielectric Probe and a model HP8714C Network Analyzer, both available from Agilent Technologies (Brookfield, Wis., U.S.A.). Substantially equivalent devices may also be employed. Energy receiver materials useful in the present invention typically have a dielectric constant—measured in the frequency range of about 900 to about 3,000 MHz—of at least about 4; alternatively, at least 4; alternatively, at least about 8; alternatively, at least 8; alternatively, at least about 15; or alternatively, at least 15.

Examples of materials that may be suitable energy receiver materials or materials susceptible to inductive heating for purposes hereof, have been reported as having the noted dielectric constants: titanium dioxide (110), titanium oxide (40-50), sugar, sorbitol, ferrous sulfate (14.2), ferrous oxide (14.2), calcium superphosphate (14-15), zircon (12), graphite, high density carbon black (1215), calcium oxide granules (11.8), barium sulfate (11.4), ruby (11.3), silver chloride (11.2), silicon (11-12), magnesium oxide (9.7), alumina (9.3-11.5), anhydrous sodium carbonate (8.4), calcite (8), mica (7), dolomite (6.8-8). Other examples include, but are not limited to, various mixed valent oxides such as magnetite (Fe₃O₄), nickel oxide (NiO) and such; ferrite, tin oxide, zinc oxide, carbon, carbon black and graphite; sulfide semiconductors such as FeS₂, CuFeS₂; silicon carbide; various metal powders, particulates or fibers, such as aluminum, copper, bronze, iron and the like; various hydrated salts and other salts, such as calcium chloride dihydrate; polybutylene succinate and poly(butylene succinate-co-adipate), polymers and co-polymers of polylactic acid, various hygroscopic or water absorbing materials or more generally polymers or copolymers or non-polymers with many sites with —OH groups; other inorganic microwave absorbers including metals, aluminum hydroxide, zinc oxide, varium titanate and other organic absorbers such as polymers containing ester, aldehyde, ketone, isocyanate, phenol, nitrile, carboxyl, vinylidene chloride, ethylene oxide, methylene oxide, epoxy, amine groups, polypyrroles, polyanilines, polyalkylthiophenes, and mixtures thereof.

It should be further noted that the present invention is not limited to the use of only one material susceptible to inductive heating, but could also include mixtures of two or more such energy receiver materials. As previously indicated, the energy receiver material may be in particulate form; consequently, it is understood that the particles of energy receiver material may include solid particles, porous particles, or may be an agglomeration of more than one particle of energy receiver material. One skilled in the art would readily appreciate the possibility of treating the surface of a particle of energy receptive additive to enhance its ability to efficiently absorb microwave energy. Suitable surface treatments include scoring, etching, and the like. The energy receiving additive may also be in the form of an absorbed liquid or semi-liquid. In particular, a solution, dispersion or emulsion of one or more effective energy receptive additives may be formulated.

In various embodiments of the present invention, the intimate association of an energy receiver material may be achieved with the optional use of a binder material. The binder material can include substances that can be applied in liquid or semi-liquid form and in which the energy receiver material can be dispersed. The term “applied” as used herein is intended to include situations where: at least a portion of the surface of a particle of material susceptible to inductive heating has an effective amount of binder material on it or containing it to facilitate adherence, via mechanical and/or chemical bonding of at least a portion of the surface to at least a portion of the material susceptible to inductive heating. In yet a further embodiment, the energy receiver material may be blended into the pulp mill furnish to disperse the energy receiver as an integral part of the manufactured paper substrate. In another embodiment the energy receiver material may be dispersed in any polymer and hot extruded into a film, cast or molded as part of polymer, co-extruded as a separate layer in a multi-layer co-extrusion or coated to the surface of a substrate as part of a multi-layer laminate. In yet another embodiment the energy receiver material can be sputter coated, spray coated, or electrodeposited onto the substrate or as a back coat to the substrate. Any commonly used technique to metalize or apply foils can also be advantageously used.

The energy receiver material can be dispersed in a binder material or dispersant such as a polymeric acrylate or polyvinyl alcohol to form a coating. The coating can be applied onto a surface of the substrate forming a subcoat or backcoat as desired. An optional surfactant can aid dispersion helping to form a coating slurry. Aqueous based slurries are desirable for ease of application, though the invention is not limited to such dispersion techniques.

The selection of a particular binder material can be made by one skilled in the art and will typically depend upon the chemical composition of the materials to be maintained in intimate association with one another. The binder material is typically prepared by the formation of a liquid or semi-liquid or slurry. In particular, a solution, dispersion or emulsion including at least one of the various, preferably polymeric binder materials identified herein may be prepared. It may be applied to the selected material by any method such as by spraying in liquid or semi-liquid form, rod coating, curtain coating, blade coating, air knife coating and the like.

Alternatively, the energy receiver material particles can be dispersed into the substrate, such as into the furnish when a paper substrate is being formed such as using a Fourdrinier paper machine. Similar dispersion into a polymer melt or into a film substrate during extrusion, for example, can be accomplished.

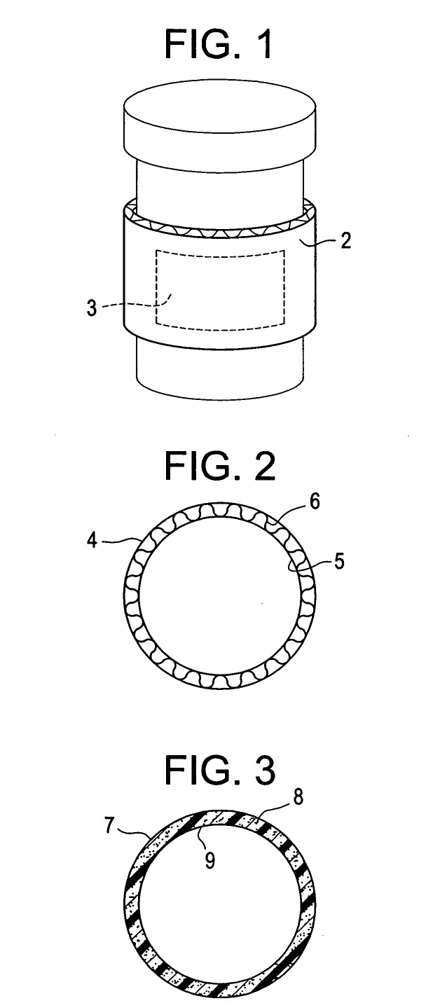

Looking now at the drawings, FIG. 1 illustrates a sleeve according to the invention. Sleeve 2 depicted is shown fitted over a prescription container. Prescription label 3 is covered by sleeve 2, sleeve 2 in practice would be sized to snuggly fit the container. Sleeve 2 shown with a top and bottom opening optionally could be tapered or sealed on the bottom or have a bottom portion such that the sleeve resembles a cup shape.

Sleeve 2 has an energy receiver material dispersed preferably on the back surface facing the prescription label. The sleeve of the invention is ideally suited for use with prescription labels formed of thermally imaging record material.

FIG. 2 teaches an alternative embodiment. FIG. 2 is a cross-section of a sleeve shown as a corrugate laminate. External ply 4 and internal ply 5 sandwich corrugation 6. The corrugation could take the form of fluting or spacers.

Although a three ply version is illustrated, any of plies 4 of 5 could be omitted or, alternatively, additional plies included. Preferably plies 4, 5, and 6 are cellulose based, though the invention is not limited to just use of cellulose based materials.

Energy receiver material could form one of the plies such as a sheet of metallized film, or alternatively could be dispersed as a coating on or in any ply. Most preferably the energy receiver material is coated on or within the internal ply corrugation 6 or coated on either surface of internal ply 5.

FIG. 3 illustrates an alternate embodiment where the energy receiver material is dispersed integral within a solid foam sleeve. The energy receiver material can be incorporated during manufacture of the foam 8. Optionally plies 7 and 9 can be laminated to the foam. With laminated designs, the energy receiver material can optionally be applied to any surface internal or external, of the plies during the lamination process.

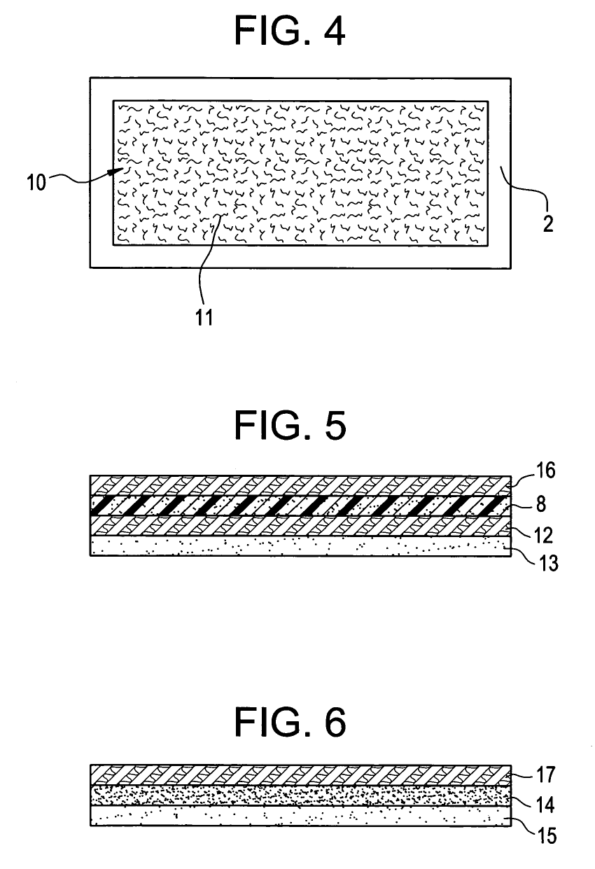

FIG. 4 is a side view of a sleeve 2 blank shown coated with a coating layer 10 having energy receiver material 11 dispersed throughout the coating layer as a homogenous dispersion therein or sprinkled and adhered onto the coating layer 10. Coating layer 10 can be a polymeric binder material or adhesive.

FIGS. 5 and 6 depict cross-section of various alternate constructions of a sleeve or tape. These examples are illustrative rather than limiting. In FIG. 5 foam 8 is shown laminated between paper plies 12 and 16. An adhesive layer 13 is coated to one surface of paper ply 12. Energy receiver material can be dispersed in adhesive layer 13 or optionally coated onto or into any ply.

FIG. 6 is a cross-section of a tape substrate showing paper 17. To the underside of paper 17 an energy receiver material is applied integrated either into binder layer 14 or adhesive layer 15.

The following examples are given to illustrate some of the features of the present invention and should not be considered as limiting. Unless otherwise indicated, all measurements, pats and proportions herein are in the metric system and on the basis of weight.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Samples were prepared and tested in a conventional microwave oven (Sharp R-230H, 1200 watt). The Sharp microwave has a “minute plus” quick heat option.

The microwave susceptor material desirably should be capable of being heated up to a temperature of about 232° C. and more preferably in a temperature range of about 150° C. to 225° C.

### EXAMPLE 1

A pressure sensitive tape susceptible to inductive heating was prepared by providing base paper 13 pounds (5896 grams) per ream. To the base paper, a coating was applied of a pressure sensitive adhesive (acrylate based, though other adhesives could be employed). The adhesive at 57.7% solids was blended with 10 parts carbon black dispersion at 48% solids using 0-5 parts of water to achieve appropriate rheology characteristics to form a coating. The carbon black was shown effective as a microwave susceptor by heating the substrate in a microwave using a Sharp carousel microwave oven (1200 watt, 2450 MHz).

### EXAMPLE 2

A styrene butadiene latex 30 parts at 50% solids, was blended with carbon black 20 parts, 48% solids and 0-5 parts water to create a coating dispersion. This coating when applied to base paper was able to be fashioned into a sleeve that would heat when placed in a microwave oven for about 30 seconds to one minute.

The following additional constructions in Examples 3 to 7 illustrate, without limitation, various alternative constructions of substrates according to the invention which can be fashioned into pressure sensitive tapes or sleeves as desired.

### Formula 1

13 parts acrylic binder polymer at 50% solids
0.2 parts surfactant (Acetylenic glycol, Surfynol™ 440, Air Products, Allentown, Pa.)
4.5 parts bronze powder, 98% sized less than 74 microns
0-10 parts water to achieve coat weight

### Formula 2

18 parts acrylic binder polymer at 50% solids
0.2 parts surfactant (acetylenic glycol)
3 parts bronze powder, 98% sized less than 74 microns
2 parts aluminum flake, particle size 8-18 microns
0-10 parts water to achieve coat weight

### Formula 3

5 parts acrylic binder polymer at 31.5% solids
0.2 parts surfactant (acetylenic glycol)
3 parts graphite powder, particle size 1-2 micron
7-15 parts water to achieve coat weight

### Formula 4

10 parts acrylic binder polymer at 31.5% solids
0.2 parts surfactant (acetylenic glycol)
3 parts graphite powder, particle size 1.2 micron
7-15 parts water added to achieve coat weight

### Formula 5

10 parts acrylic binder polymer at 31.5% solids
0.2 parts surfactant (acetylenic glycol)
3 parts graphite powder, particle size 1.2 micron
3 parts magnesium iodate tetrahydrate
7-15 parts water added to achieve coat weight

### Formula 6—subcoat

45 parts styrene butadiene rubber latex at 50% solids
1 parts surfactant (acetylenic glycol)
70 parts calcined clay
70-100 parts water to achieve coat weight and wet out clay

### Formula 7—topcoat

100 parts carboxylated polyvinyl alcohol at 15% solids
0.4 parts surfactant (acetylenic glycol)
50 parts pigment dispersion at 50% solids
5 parts zinc stearate dispersion at 44% solids
35 parts cross-linking agent at 12.5% solids
5-10 parts water to achieve coat weight

### EXAMPLE 3

Layer 1—Formula 8—topcoat @ 2.0 lbs/ream (0.9 kg/ream)
Layer 2—Formula 6—subcoat @ 5.0 lbs/ream (2.2 kg/ream)
Layer 3-paper substrate
Layer 4—Formula 1—microwave susceptor @ 6 lbs/ream (2.7 kg/ream)

### EXAMPLE 4

Layer 1—Formula 8—topcoat @ 2.0 lbs/ream (0.9 kg/ream)
Layer 2—Formula 6—subcoat @ 5.0 lbs/ream (2.2 kg/ream)
Layer 3-paper substrate
Layer 4—Formula 2—microwave susceptor @ 6 lbs/ream (4.08 kg/ream)

### EXAMPLE 5

Layer 1—Formula 8—topcoat @ 2.0 lbs/ream (0.9 kg/ream)
Layer 2—Formula 6—thermal subcoat @ 5.0 lbs/ream (2.2 kg/ream)
Layer 3—Formula 3—microwave susceptor @ 2 lbs/ream (0.9 kg/ream)
Layer 4-paper substrate

### EXAMPLE 6

Layer 1—Formula 7—topcoat @ 2.0 lbs/ream (0.9 kg/ream)
Layer 2—Formula 6—thermal basecoat @ 5.0 lbs/ream (2.2 kg/ream)
Layer 3—Formula 4—microwave susceptor @ 3.5 lbs/ream (1.6 kg/ream)
   Layer 4-paper substrate

### EXAMPLE 7

Layer 1—Formula 7—topcoat @ 2.0 lbs/ream (0.9 kg/ream)
Layer 2—Formula 6—basecoat (5.0 lbs/ream (2.2 kg/ream)
Layer 3—Formula 5—microwave susceptor @ 6 lbs/ream (2.7 kg/ream)
Layer 4—paper substrate
   Optionally magnesium iodate tetrahydrate (dehydrates at 210° C. as a temperature controlling function) can be added to any of the layers containing the microwave susceptor.
   A Sharp Carousel microwave oven (1200 Watt, 2450 MHz) can be used to heat these substrates.
   Reams were 3300 sq. ft. (306.58 sq. meters), 500 sheets, 8.5×11 inches (21.59 cm×27.94 cm).

The principles, preferred embodiments, and modes of operation of the present invention have been described in the foregoing specification. The invention which is intended to be protected herein, however, is not to be construed as limited to the particular forms disclosed, since these are to be regarded as illustrative rather than restrictive variations and changes can be made by those skilled in the art without departing from the spirit and scope of the invention.

What is claimed is:

1. A container sleeve comprising a tubular member comprising a substrate and at least one opening therein for receiving and retaining a container, said tubular member comprising a substrate having applied thereon or therein an energy receiver material for heating the container sleeve in response to electromagnetic energy.

2. The container sleeve according to claim 1 wherein the tubular member has openings at the top and bottom for sliding of the container sleeve onto a container.

3. The container sleeve according to claim 1 wherein the energy receiver material is a microwave susceptor applied to a surface of the container sleeve.

4. The container sleeve according to claim 1 wherein the energy receiver material is a microwave susceptor particle.

5. The container sleeve according to claim 1 wherein the energy receiver material comprises a layer of metallized film.

6. The container sleeve according to claim 1 wherein the energy receiver material is a microwave susceptor dispersed within the substrate.

7. The container sleeve according to claim 1 wherein the substrate comprises at least one layer of a polymeric material.

8. The container sleeve according to claim 1 wherein the substrate is a laminate of one or more plies of a cellulosic material.

9. The container sleeve according to claim 8 wherein in addition at least one ply is corrugated, dimpled or fluted.

10. The container sleeve according to claim 8 wherein at least one ply is selected from film, foam, paper, or fiberboard.

11. A pressure sensitive tape comprising a substrate having a top and bottom surface and having applied thereon or therein an energy receiver material for heating the pressure sensitive tape in response to electromagnetic energy and an adhesive layer applied to a surface of the substrate.

12. The pressure sensitive tape according to claim 11 wherein the energy receiver material is a microwave susceptor applied to a surface of the substrate.

13. The pressure sensitive tape according to claim 11 wherein the energy receiver material is a microwave susceptor particle.

14. The pressure sensitive tape according to claim 11 wherein the energy receiver material comprises a layer of metallized film.

15. The pressure sensitive tape according to claim 11 wherein the energy receiver material is a microwave susceptor dispersed within the substrate or within the adhesive layer.

16. The pressure sensitive tape according to claim 11 wherein the substrate comprises at least one layer of a polymeric material.

17. The pressure sensitive tape according to claim 11 wherein the substrate is a laminate of one or more plies of a cellulosic material.

18. The pressure sensitive tape according to claim 17 wherein in addition at least one ply is corrugated, dimpled or fluted.

19. The pressure sensitive tape according to claim 17 wherein at least one ply is selected from film, foam, paper, or fiberboard.

20. A method of obscuring confidential information comprising:
providing a prescription container having an adhered label of thermally imaging recording material comprising a chromogenic material and a developer material;
applying a sleeve over the prescription container to form an assembly, the sleeve comprising a tubular member comprising a substrate and at least one opening therein for receiving and retaining the prescription container, said tubular member comprising a substrate having applied thereon or therein an energy receiver material for heating the container sleeve in response to electromagnetic energy;
subjecting the sleeve and prescription container assembly to electromagnetic energy so as to heat the container sleeve thereby reacting the heat sensitive recording material so as to colorize the chromogenic material of the thermally imaging recording material.

21. The method according to claim 20 wherein the electromagnetic energy is microwave.

22. A method of obscuring confidential information comprising:
providing a prescription container having an adhered label of thermally imaging recording material comprising a chromogenic material and a developer material;
applying a pressure sensitive tape over the label of the prescription container to form an assembly, the pressure sensitive tape comprising a substrate having a top and bottom surface and having applied thereon or therein an energy receiver material for heating the substrate in response to electromagnetic energy and having applied onto the bottom surface thereof a pressure sensitive adhesive;
subjecting the substrate and prescription container assembly to electromagnetic energy so as to heat the substrate thereby reacting the heat sensitive recording material so as to colorize the chromogenic material of the thermally imaging recording material.

23. The method according to claim 22 wherein the electromagnetic energy is microwave.
